(19) United States
(12) Patent Application Publication
(10) Pub. No.: US 2017/0253333 A1
(43) Pub. Date: Sep. 7, 2017

(54) UNMANNED VEHICLE

(71) Applicant: HELICEO, Nantes (FR)

(72) Inventor: Jean-Francois BAUDET, Nantes (FR)

(21) Appl. No.: 15/508,789

(22) PCT Filed: Sep. 3, 2015
(86) PCT No.: PCT/FR2015/052332

§ 371 Date: Mar. 3, 2017

(30) Foreign Application Priority Data
Sep. 5, 2014 (FR) 1458331

(51) Int. Cl. B64C 39/02; B64F 5/40; B64C 1/30; B64C 25/54

(52) U.S. Cl. CPC B64C 39/024; B64C 25/54; B64F 5/40; B64C 1/30

(57) ABSTRACT

The present invention relates to an unmanned vehicle including:—a vehicle chassis (2) that has at least one actuator (3) involved in the driveability of the vehicle (1);—a set of on-board electronic components, namely at least one on-board electronic/computer control system;—a telecommunication unit; and—a geolocation unit. According to the invention, the on-board electronic components are arranged within a carrier so as to form, together, a removable technical unit (5) that is removably mounted on the vehicle chassis (2). The technical unit (5) and the vehicle chassis (2) include a mechanical/electrical interface unit (7) that are suitable, on one hand, for the releasable mechanical attachment of the removable technical unit (5) to the vehicle chassis (2) and, on the other hand, for the releasable electrical connection of the technical unit (5) to the at least one driveability actuator (3).

### TECHNICAL FIELD TO WHICH THE INVENTION RELATES

The present invention relates to the field of the unmanned vehicles, in particular the aerodynes of the sailwing or multi-rotor type.

### TECHNOLOGICAL BACKGROUND

After a significant development in the field of Defence, many civilian applications are appearing for the unmanned vehicles.

These vehicles generally consist in small machines that may be remotely controlled (in particular by radio waves), or be semi-attended or unattended. For example, in the aerial field, these vehicles are known as drones or “unmanned air vehicle” (UAV).

For their operation and their mission, these vehicles take on-board a set of electronic components, namely, in particular:
an on-board electronic/computer control system, in particular for controlling actuator(s) intervening in the driveability,
a source of electrical energy,
at least one instrument of acquisition for taking images and/or physical measurements,
telecommunication means, and
geolocation means.

These on-board electronic components are usually distributed over the vehicle frame, which may complicate the maintenance and/or repairing operations.

Moreover, the cost price of these vehicles is often relatively expensive due to the presence of these on-board electronic components.

Consequently, there exists a need for a new structure of unmanned vehicles, whose—maintenance and/or repairing operations would be facilitated, and/or—the cost price would be reduced.

### OBJECT OF THE INVENTION

In this context, the applicant has developed such a new structure of unmanned vehicle, providing an innovative solution that allows facilitating the maintenance/repairing operations, but also reducing the cost price of this type of vehicle.

In this respect, the unmanned vehicle comprises a vehicle frame that carries:
a/ at least one actuator intervening in the driveability of said vehicle,
b/ a set of on-board electronic components, namely at least:
an on-board electronic/computer control system, in particular for controlling said driveability actuator,
telecommunication means,
geolocation means.

According to the invention, said on-board electronic components are arranged within a support, to form together a removable technical unit that is dismountably added on said vehicle frame. The technical unit and the vehicle frame include mechanical/electrical interface means that are adapted, on the one hand, to the removable mechanical fixation of said removable technical unit with said vehicle frame and, on the other hand, to the removable electrical connection of said technical unit with said at least one driveability actuator.

Such a vehicle has for interest to allow a simple and fast replacement of the removable technical unit, without requiring a direct intervention on the on-board electronic components.

The removable technical unit advantageously consists in a versatile structure that is adaptable to, and compatible with, a range of vehicle frames.

This removable technical unit has also for interest to keep in common the main functions of the vehicle, with a possibility of interchangeability over a range of vehicle frames including different driveability (in particular propulsion) means.

According to other advantageous embodiment characteristics, which can be taken in combination or independently of each other:
the on-board electronic components also comprise at least one source of electrical energy, and said at least one source of electrical energy is located within the support to also form the removable technical unit, or directly on the frame, independently from said removable technical unit;
the on-board electronic components also comprise at least one instrument of acquisition, for taking images and/or for taking physical measurements, and said at least one instrument of acquisition is located within the support to also form the removable technical unit, or directly on the frame, independently of said removable technical unit;
the support of the removable technical unit is in the form of a box in which the on-board electronic components are integrated; the support of the removable technical unit advantageously includes a front wall forming a lid that is mobile between two positions: an open position, for access to the on-board electronic components, and a closed position, to prevent the access to said on-board electronic components;
the vehicle frame includes a place in which is added said removable technical unit and that is provided with an opening, and in that the support of the removable technical unit includes a front wall intended to close said opening; the front wall has advantageously an aerodynamic profile;
the support of the removable technical unit includes housings for removably receiving the on-board electronic components;
the mechanical/electrical interface means include at least one power connector, a first part of which is carried by the vehicle frame and a second, complementary part of which is carried by the removable technical unit;
the vehicle frame includes at least one carrier member chosen among: at least one wing, adapted to ensure a driveability in the air carrier medium, and/or at least one floater, adapted to ensure a driveability on the water carrier medium, and/or means adapted to ensure a driveability on the terrestrial carrier medium; in this case, the wing advantageously consists in: at least one fixed wing, and/or at least one rotary-wing, for example of the sustentation rotor type; preferably, also, the fixed wing is a sailwing, including an intrados and an extrados, which extrados includes a place for receiving the removable technical unit, and which removable technical unit includes a front wall having an aerodynamic profile to form a part of said extrados;
the electronic/computer control system includes: piloting means adapted to the different vehicle frames able to be associated with the removable technical unit, and means for the selection of piloting means adapted to the associated vehicle frame.

The present invention also relates to a system of unmanned vehicles, comprising:
a single removable technical unit, and
at least two different vehicle frames.

The present invention also relates to a method for assembling an unmanned vehicle according to the invention, which method comprises the following operations:
an operation of implantation of said removable technical unit on the vehicle frame by implementation of the mechanical/electrical interface means, and
an operation of selection of the piloting means adapted to said associated vehicle frame, among the piloting means adapted to the different vehicle frames able to be associated with said removable technical unit.

### DETAILED DESCRIPTION OF THE INVENTION

The present invention will be further illustrated, without being limited thereby, by the following description of different embodiments shown in the appended drawings, in which:

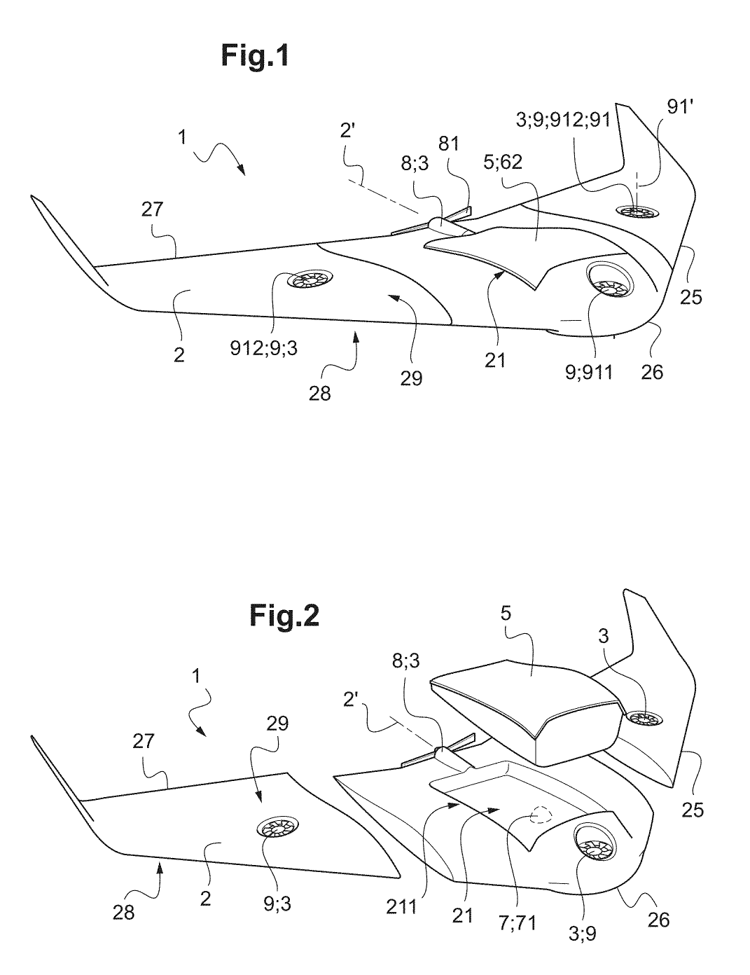

FIG. 1 shows a first unmanned vehicle according to the invention, namely an aerial vehicle of the sailwing type, shown in a perspective view oriented towards the extrados side and the nose thereof, and in which the removable technical unit is suitably added in a dedicated place in the vehicle frame;

FIG. 2 shows the aerodyne according to FIG. 1, in which the removable technical unit is extracted from its dedicated place in the vehicle frame;

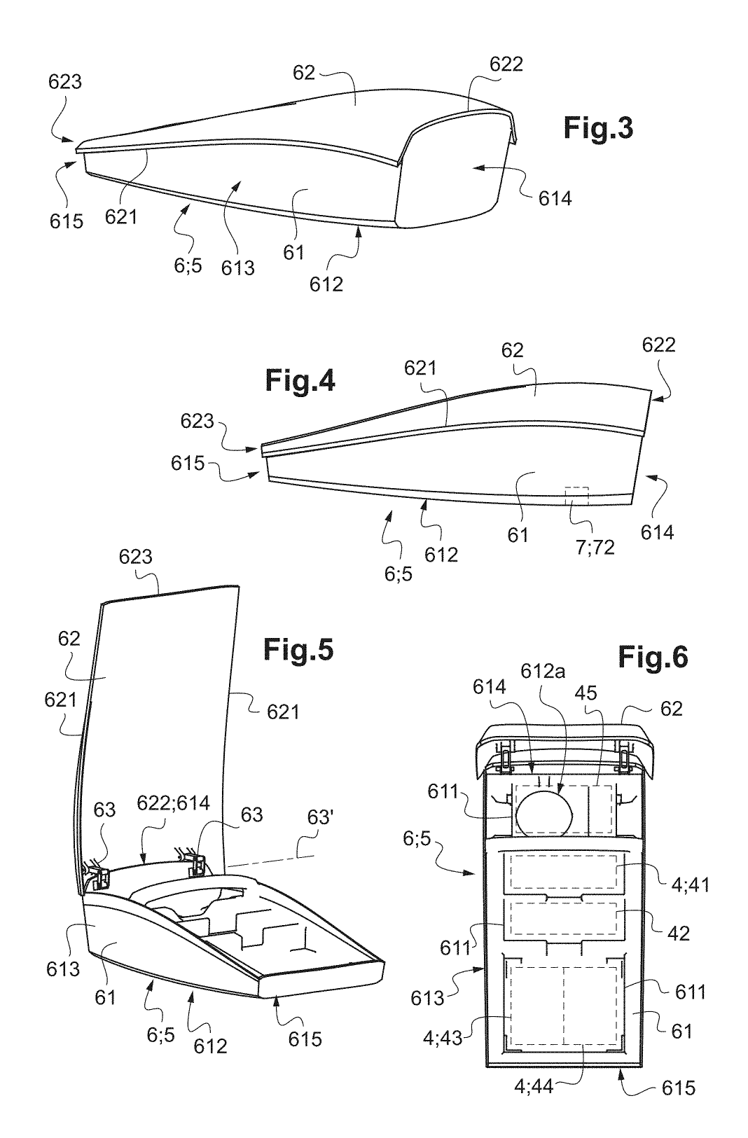

FIGS. 3 and 4 show in perspective view and in side view, respectively, the removable technical unit isolated from the vehicle frame and in a closed configuration;

FIGS. 5 and 6 show in perspective view and in top view, respectively, the removable technical unit isolated from the vehicle frame and in an open configuration;

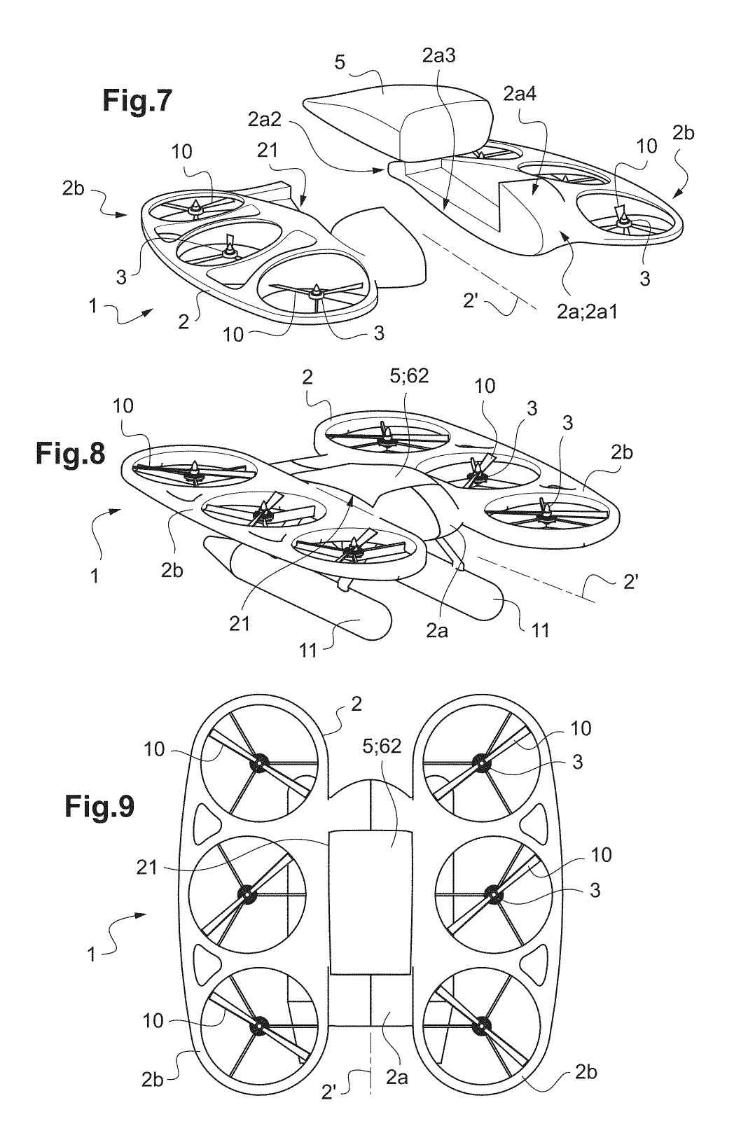

FIG. 7 shows a second unmanned vehicle according to the invention, namely an aerial vehicle of the multi-rotor type, shown in a perspective view oriented towards the extrados side and the nose thereof, and in which the removable technical unit is extracted from its place provided in the vehicle frame;

FIGS. 8 and 9 show in perspective view and in top view, respectively, a variant of the second unmanned vehicle, which can be distinguished by the presence of floaters to ensure a driveability on the water carrier medium.

The vehicles 1 according to the invention, shown in the above-mentioned figures, consist in vehicles with no pilot on board (also called “unmanned vehicle” (UV)).

By “unmanned vehicle”, it is understood in particular a vehicle with nobody/no people on board, which may be :
remotely controlled, for example via radio waves, and/or
semi-attended or unattended, thanks to an on-board electronic/computer control system.

An “unmanned vehicle” according to the invention includes at least one carrier member adapted to ensure a driveability in a carrier medium of interest.

“Carrier medium” encompasses in particular air, water and ground.

The “unmanned vehicles” according to the invention hence encompasses in particular:
an aerial vehicle (UAV for “unmanned aerial vehicle”), commonly called “drone”, as shown in FIGS. 1, 2 and 7, provided with at least one wing adapted to ensure a driveability in the air carrier medium,
a surface naval vehicle (USV for “unmanned surface vehicle”), for the operation of the surface of water, as shown in FIGS. 8 and 9, provided with at least one floater adapted to ensure a driveability on the water carrier medium,
a terrestrial vehicle (UGV for “unmanned ground vehicle”), not shown, provided with means (wheels, caterpillars, etc.) adapted to ensure a driveability on the terrestrial carrier medium, and
an undersea vehicle (UUV for “unmanned undersea vehicle”), for the undersea exploitation (not shown).

The “unmanned vehicles” according to the invention also encompasses the hybrid vehicles, i.e. adapted to at least two different carrier mediums (for example, UAV (air) and USV (water)).

Each vehicle 1 according to the invention, in the different embodiments, comprises a vehicle frame 2 that carries:
a/ at least one actuator 3 intervening in the driveability of said vehicle 1, also called “driveability actuator”, and
b/ a set of on-board electronic components 4 (shown in FIG. 6), intervening in particular in the piloting of said driveability actuator(s) 3.

By “driveability”, it is meant in particular the propulsion, principle that allows a body to move in its surrounding space. It appeals in particular to a propeller that transforms into a driving power the energy provided by the driveability actuator.

By “driveability actuator”, it is understood in particular a motor 3 that is carried by the frame 2 and that intervenes in the displacement of the vehicle 1 in its environment.

This driveability actuator 2 advantageously operates with electrical and/or thermal energy.

As developed hereinafter in relation with the different vehicles 1 according to the invention, this motor 3 is advantageously intended to operate into rotation a propeller, a turbine, a wheel, etc., adapted to the carrier medium.

The on-board electronic components 4 are chosen at least among:
an on-board electronic/computer control system 41, in particular for controlling the driveability actuators 3 equipping the vehicle 1,
a source of electrical energy 42,
telecommunication means 43,
geolocation means 44.

The on-board electronic/computer control system 41 advantageously comprises:
low-energy-consumption microprocessors or microcontrollers,
a computer program part, in part or entirely programmed in the material, generally in a random-access memory (ROM), an EPROM, an EEPROM, a FLASH memory.

The computer program part comprises program code means for piloting the on-board electronic components 4 of the vehicle, when said computer program is executed by said control system 41.

The source of electrical energy 42 advantageously consists in a battery.

This source of electrical energy 42 is intended to power supply the on-board electronic components 4 and possibly the driveability actuators 3 equipping the vehicle 1.

The telecommunication means 43 advantageously consist in radiocommunication means.

These telecommunication means 43 are useful in particular for the exchange of data with a ground station for controlling and collecting detection results.

The geolocation means 44 consist for example in GPS (“Global Positioning System”) means.

The on-board electronic components 4 also advantageously comprise at least one instrument of acquisition 45, for taking images (photography or video) and/or for taking physical measurements (for example, radar, infrared, radio and/or electro-optical).

According to the invention, some at least of the on-board electronic components 4 are grouped within a removable technical unit 5 that is dismountably (removably) added within a place 21 formed on the vehicle frame 2.

Such a removable technical unit 5 hence advantageously consists in a structure of the one-piece type, able to be mounted and dismounted as a single block (in one piece) with respect to the vehicle frame 2. The removable technical unit 5 also advantageously forms a versatile structure that is adaptable to, and compatible with, a complete range of vehicle frames 2.

The removable technical unit 5 is shown in more details in FIGS. 3 to 6.

This removable technical unit 5 comprises a support 6 within which are arranged the above-mentioned on-board electronic components 4 (visible in FIG. 6).

Herein, the removable technical unit 5 integrates:
the on-board electronic/computer control system 41,
the source of electrical energy 42,
the telecommunication means 43,
the geolocation means 44.

The on-board electronic/computer control system 41 also advantageously includes:
piloting means adapted to the different vehicle frames 2 able to be associated with the removable technical unit 5, and
means for the selection of piloting means adapted to the associated vehicle frame 2.

Preferably, the piloting means comprise a computer program including at least two program code means that are each adapted to the piloting of a vehicle frame 2 able to be associated with the removable technical unit 5, when said computer program is executed by said on-board electronic/computer control system 41.

Preferably, the selection means also consist in program code means of said computer program, for the selective execution of one of the program code means of the piloting means, when said computer program is executed by said on-board electronic/computer control system 41.

As an alternative, not shown, the source of electrical energy 42 could be arranged directly on the frame 2, independently of the removable technical unit 5.

The instrument of acquisition 45 is herein located within the support 6 to also form a part of the removable technical unit 5.

As an alternative, not shown, this instrument of acquisition 45 could be arranged directly on the frame 2, independently of the removable technical unit 5.

The on-board electronic components 4 are suitably electrically connected within a removable technical unit 5, advantageously through the on-board electronic/computer control system 41.

The support 6 of the removable technical unit 5 is in the form of a box in which are integrated the above-mentioned on-board electronic components 4 (including herein the source of electrical energy 42 and the instrument of acquisition 45).

Preferably, this support 6 constitutes a continuous envelop so as to ensure an optimal protection of the added electronic components 4, in particular as regards the mechanical impacts, but also preferably liquid tight.

For that purpose, this support 6 has herein a generally parallelepipedal shape, including:
a base 61 in which are arranged housings 611 opening on top to each receive one at least of the on-board electronic components 4, and
a front wall 62 forming a lid, adapted to close said housings 611.

The base 61 consists for example in a part made of a plastic, composite or metal material.

This base 61 comprises a bottom wall 612 extended by lateral walls 613, by a front wall 614 and by a rear wall 615.

In particular, the bottom wall 612 is herein provided with a lumen 612a for the positioning of the lens of the instrument of acquisition 45 for image taking.

The front wall 62 is itself delimited by two lateral edges 621, by a front edge 622 and by a rear edge 623.

This front wall 62 is mobile between two positions:
an open position, for access to the housings 611 of the base 61 and, as the case may be, to the added on-board electronic components 4, and
a closed position, to prevent the access to the housings 611 of the base 61 and, as the case may be, to said on-board electronic components 4.

Herein, the front edge 622 of the front wall 62 and the upper edge of the front wall 614 of the base 61 cooperate with each other through means 63 of the hinge type, defining an axis of rotation 63′ for the operation of the front wall 62 between its two open and closed positions.

The front edge 622 of the front wall 62 and the front wall 614 of the base 61, cooperating through hinge means 63, are intended to be located on the front side of the vehicle 1 so as to reinforce the holding in closed position of the front wall 62.

As developed hereinafter, this front wall 62 is intended to close an opening for access to the place 21 of the vehicle frame 2.

For this reason, the front wall 62 has advantageously an aerodynamic profile.

By “aerodynamic profile”, it is generally understood a profile whose shape allows reducing the most possible the resistance to air, when the vehicle moves in the air.

Herein, this front wall 62 includes a camber, with a descending slope from the front wall 614 to the rear wall 615 of the base 61.

Generally, this front wall 62 may constitute a part of an aerodynamic fairing, i.e. an external coating increasing the aerodynamics of the vehicle 1 in movement.

In the case of an aerial vehicle (in particular, FIGS. 1 and 2), the aerodynamic profile is in addition advantageously used to participate in generating a lift, i.e. a force perpendicular to the flow that passes through it.

The place 21 intended to receive the removable technical unit 5 consists in a recess whose shape corresponds advantageously, within the clearance, to the external contour of the base 61 of the removable technical unit 5.

This place 21 is provided with an opening 211 (FIG. 2), through which is added and extracted this removable technical unit 5.

Herein, the opening 211 is closed by the front wall 62 of the removable technical unit 5, i.e. the contour of the front wall 62 corresponds, within the clearance, to the contour of this opening 211 (FIGS. 1 and 8).

To ensure the dismountable character thereof, the removable technical unit 5 and the vehicle frame 2 include mechanical/electrical interface means 7 that are adapted, on the one hand, to the removable mechanical fixation of said removable technical unit 5 with said vehicle frame 2 and, on the other hand, to the removable electrical connection of said technical unit 5 with said at least one driveability actuator 3.

“Electrical connection” advantageously encompasses the transmission of data between said technical unit 5 and said at least one driveability actuator 3.

The mechanical/electrical interface means 7 herein comprise a power connector:
a first part 71 (male or female) of which is carried by the vehicle frame 2 (FIG. 2) and
a second, complementary part 72 (respectively female or male) of which is carried by the removable technical unit 5 (FIG. 4).

The first part 71 of the mechanical/electrical interface means 7 is connected to the electrical circuit of the frame 2.

This electrical circuit also includes the driveability actuators 3, for the electrical power supply and the control thereof.

According to the case, this electrical circuit may also carry the source of electrical energy 42, for the power supply of the driveability actuators 3 and for the power supply of said removable technical unit 5 via the mechanical/electrical interface means 7.

The second part 72 of the mechanical/electrical interface means 7 is itself connected to the electrical circuit of the removable technical unit 5, on which are implanted certain at least of the different electronic components 4 (according to the case with or without the source of electrical energy 42 and/or the instrument of acquisition 45).

In particular, the second part 72 of the mechanical/electrical interface means 7 is arranged in the bottom wall 612 of the base 61.

In practice, an operator adds the removable technical unit 5 (integrating the electronic components 4) on the vehicle frame 2, as the case may be by introducing the base 6 thereof in the dedicated place 21.

During this positioning, the mechanical/electrical interface means 7 are advantageously implemented automatically.

Herein, the first part 71 carried by the vehicle frame 2 and the second part 72 carried by the removable technical unit 5 are automatically nested into each other.

The means for the selection of piloting means adapted to the associated vehicle frame are then implemented, so as to activate the corresponding piloting means.

The method of assembling an unmanned vehicle 1 according to the invention hence advantageously comprises the following steps:
an operation of implantation of the removable technical unit 5 (integrating certain at least of the electronic components 4) on the vehicle frame 2 by implementation of the mechanical/electrical interface means 7, as the case may be by introducing the base 6 thereof into the dedicated place 21, and
an operation of selection of the piloting means adapted to said associated vehicle frame 2, among the piloting means adapted to the different vehicle frames 2 able to be associated with the removable technical unit 5.

During a mission, conventionally per se, the control system 6 pilots the different electronic components of the vehicle 1, in particular:
the electronic components 4 integrated in the removable technical unit 5, and
the driveability actuator 3 equipping the vehicle frame 2.

To replace the removable technical unit 5, or to add this removable technical unit 5 on another vehicle frame 2 to form a new vehicle 1, it is sufficient for the operator to exert a traction on this removable technical unit 5 with respect to the vehicle frame 2 (possibly with inactivation of the mechanical/electrical interface means 7).

Generally, the invention also relates to the system of unmanned vehicles, comprising:
a single removable technical unit 5, and
at least two different vehicle frames 2.

A same removable technical unit 5 may be associated successively with different vehicle frames 2 to obtain different functional vehicles 1, as described hereinafter in relation with the different exemplary embodiments.

According to a First Exemplary Embodiment

A first exemplary embodiment of a vehicle according to the invention is schematically shown in FIGS. 1 and 2.

The corresponding vehicle 1 consists in an aerial vehicle, i.e. in particular an aerodyne whose sustentation comes from an aerodynamic lift.

For that purpose, the frame 2 of this vehicle 1 includes carrier members of the wing type, adapted to ensure a lift in the air carrier medium.

This frame 2 consists in a fixed wing in the form of a sailwing, i.e. in particular an aerodyne having no empennage, and whose set of different mobile surfaces necessary for the piloting thereof is located on the fixed wing.

Such a vehicle 1 is for example interesting in the topography, marine (scientific research, offshore fishery, etc.) or agriculture fields.

The frame 2 is equipped with:
propulsion/traction means 8, hereinafter more generally called propulsion means, and
sustentation means 9, distinct from said propulsion means 8, intervening in a function of vertical takeoff and landing.

The corresponding vehicle 1 is hence adapted to be piloted between two flying modes:—a so-called “sustentation” mode, ensured by the sustentation means 9, and—a so-called “propulsion” mode, ensured by the propulsion means 8.

The frame 2 of the vehicle 1 has herein generally a delta-wing shape, which is herein composed of two simple trapezoidal wings that are dismountable and of positive sweep (FIG. 2).

This frame 2 includes a vertical and front/rear middle plane 2′ (schematically represented by an axis on FIGS. 1 and 2), oriented perpendicularly to the general horizontal plane in which this frame 2 extends.

The frame 2 includes edges, on either side of this middle plane 2′:
two front, leading edges 25, herein rectilinear, which connect to each other in a V-shape on a nose 26, and
two rear, trailing edges 27.

In particular, the leading edges 25 are in positive sweep, each forming an angle lower than 90° with the middle plane 2′ of the frame 2.

The trailing edges 27 herein advantageously consist in ailerons for controlling the vehicle 1 in roll, associated with a servomotor also forming one of the driveability actuators 3 of the vehicle 1.

The frame 2 also includes an intrados 28 (lower face) and an extrados 29 (upper face) ensuring the lift.

According to the invention, the extrados 29 includes the place 21 for receiving the removable technical unit 5 in a nested arrangement.

This place 21 is advantageously arranged so as to extend on either side of the middle plane 2′.

As also shown in FIG. 1, the front wall 62 of the removable technical unit 5 has an aerodynamic profile to form a part of the extrados 29.

The sustentation means 9 are useful for vertical takeoff and landing, also called VTOL.

These sustentation means 9 are of the multi-rotor type, i.e. they comprise several sustentation rotors 91 each driven in rotation about an axis 91′ by an above-mentioned driveability actuator 3.

These sustentation means 9 herein comprise three sustentation rotors 91, i.e.:
a front sustentation rotor 911, which is arranged near the nose 26 of the frame 2 and on the middle plane 2′ of this frame 2, and
two rear sustentation rotors 912, which are arranged symmetrically on either side of the middle plane 2′, each near one of the trailing edges 27.

The vehicle 1 is also equipped with propulsion means 8 intended to create a force (thrust), which results from the acceleration of a mass of air.

The propulsion means 8 herein comprise a propeller 81 arranged on the middle plane 2′ of the wing 2, in a rear recess of the sweep.

The propeller 81 is herein propulsive. As an alternative or as a complement, at least one tractor propeller could be provided.

Moreover, the propulsion means 8 are advantageously equipped with operation means (not shown) for the orientation thereof on either side of a middle plane 2′, i.e. advantageously according to a pivotal degree of freedom about a vertical axis of rotation extending in the middle plane 2′.

For example, these operation means consist in a servomotor also constituting a driveability actuator.

This feature allows a piloting of the yaw axis during the flight of the aerodyne 1.

The propulsion means 8 and the sustentation means 9 may be associated with a same source of energy, or preferably with two distinct on-board sources of energy (not shown), respectively.

It this second case, preferably, the propulsion means 8 are associated with their proper source of energy (for example, a battery for an electrical propulsion or a source of thermal energy for a thermal propulsion), and the sustentation means 9 are associated with their proper source of energy (for example, a battery for an electrical sustentation or a source of thermal energy for a thermal sustentation).

In this case, preferably:
the battery 42 corresponds to the source of energy integrated in the remote technical unit 5, and
the source of thermal energy is directly carried by the frame 2.

Preferably, the sources of energy are provided for an electrical sustentation and a thermal propulsion.

The control system 41 hence pilots the propulsion means 8 and the sustentation means 9.

These control means 41 intervene in particular in the piloting of:
the ailerons 27 for controlling the roll, by piloting an associated servomotor,
the speed of rotation of each of the sustentation rotors 91, by intervening on the associated motors 3,
the speed of rotation of the propulsion rotor 81, by piloting the associated motor 3.

The control system 41 comprises in particular conversion means (also called “transition means”), advantageously in the form of a computer program, which are adapted to pilot the propulsion means 8 and the sustentation means 9, so as to ensure a transition of flight of said vehicle 1 (advantageously unattended) between the above-mentioned “sustentation” mode and “propulsion” mode.

According to a Second Embodiment

A second exemplary embodiment of a vehicle according to the invention is schematically shown in FIG. 7.

The corresponding vehicle 1 also consists in an aerial vehicle, i.e. in particular an aerodyne whose sustentation comes from an aerodynamic lift.

It can be distinguished from the first embodiment in that it includes rotary wings 10 of the multi-rotor type, intervening in the propulsion/traction and also in the sustentation of the vehicle.

More precisely, the frame 2 includes a vertical and front/rear middle plane 2′ (schematically represented by an axis in FIG. 7), oriented perpendicularly to the general horizontal plane in which this frame 2 extends.

This frame 2 has a generally parallelepipedal shape, which is consisted of different parts:
a central part 2a at which is arranged the place 21 for receiving the remote technical unit 5, and
two lateral parts 2b, extending laterally the central part 2a and in each of which are implanted rotary wings 10.

As shown in this FIG. 7, the frame 2 is adapted to be divided into two identical elements according to the middle plane 2′. Each element comprises one half of the central part 2a and one of the lateral parts 2b.

The rotary wings 10 consist in rotors, each driven into rotation by an above-mentioned driveability actuator 3.

These rotors 10 are herein six in number, distributed in the lateral parts 2b of the frame 2, on either side of the middle plane 2′ of the frame 2.

The central part 2a of the frame 2 includes:
a front leading edge or nose 2a1, and
a rear, trailing edge 2a2.

This central part 2a also includes an intrados 2a3 (lower face) and an extrados 2a4 (upper face) participating to the lift.

The extrados 2a4 here again includes the place 21 for receiving the remote technical unit 5.

This place 21 is advantageously arranged so as to extend on either side of the middle plane 2′. It is intended to be formed by the two associated parts of frame 2.

The front wall 62 of the remote technical unit 5 has an aerodynamic profile to form a part of the extrados 2a4 (shown in FIGS. 8 and 9).

In practice, the control system 41 of the remote technical unit 5 hence pilots the speed of rotation of each of the rotors 10, by intervening on the respective associated motors 3 and ensuring the electrical power supply thereof.

According to a Third Embodiment

A third exemplary embodiment of a vehicle according to the invention is shown in FIGS. 8 and 9.

The corresponding vehicle 1 is similar to that described hereinabove in relation with FIG. 7 and can be distinguished therefrom only by the presence of carrier members in the form of floaters.

According to this third embodiment, we can hence see the frame 2 including a vertical and front/rear middle plane 2′ (schematically represented by an axis in FIGS. 8 and 9), oriented perpendicularly to the general horizontal plane in which this frame 2 extends.

The frame 2 still has a generally parallelepipedal shape, which is consisted of a central part 2a at which is arranged the place 21, laterally extended by two lateral parts 2b in each of which are implanted rotary wings 10.

The rotary wings 10 consist in rotors each driven into rotation by an above-mentioned driveability actuator 3.

The extrados 2a4 of the central part 2a here again includes the place 21 for receiving the removable technical unit 5.

The intrados 2a3 of the central part 2a receives for its part two carrier members 11, in the form of floaters, which are adapted to ensure a driveability of the vehicle in the water carrier medium.

Each carrier member 11 comprises a cylindrical floater that extends parallel to the median plane 2′ of the vehicle frame 2 and that is fastened to the vehicle frame 2 through a linking arm.

Preferably, these carrier members 11 integrate means for generating a propulsion in the water medium, for example a marine turbine associated with a driveability actuator or any other propulsion system.

The corresponding vehicle 1 is hence adapted to be piloted between two driveability modes, controlled by the control system 41 integrated to the removable technical unit 5:
a so-called “navigation” mode, floating at the surface of water and whose displacement is ensured by a piloting of the water propulsion means, and
a so-called “flight” mode, progressing in the air medium and whose displacement is insured by a piloting of the rotary-wing 10.

According to a not-shown variant, the intrados 2a3 of the central part 2a receives two carrier members that are adapted to ensure a terrestrial propulsion, for example wheels or caterpillars.

The corresponding vehicle 1 is hence adapted to be piloted between two driveability modes, controlled by the control system 41 integrated to the removable technical unit 5:
a so-called “terrestrial propulsion” mode, at the surface of the ground and whose displacement is ensured by a piloting of the terrestrial propulsion means, and
a so-called “flight” mode, progressing in the air medium and whose displacement is insured by a piloting of the rotary wing 10.

1-15. (canceled)

16. An unmanned vehicle, comprising a vehicle frame (2) that carries:
a/ at least one actuator (3) intervening in the driveability of said vehicle (1),
b/ a set of on-board electronic components (4), namely at least:
an on-board electronic/computer control system (41), in particular for controlling said driveability actuator (3),
telecommunication means (43),
geolocation means (44),
wherein said on-board electronic components (4) are arranged within a support (6), to form together a removable technical unit (5) that is dismountably added on said vehicle frame (2),
which technical unit (5) and which vehicle frame (2) include mechanical/electrical interface means (7) that are adapted, on the one hand, to the removable mechanical fixation of said removable technical unit (5) with said vehicle frame (2) and, on the other hand, to the removable electrical connection of said technical unit (5) with said at least one driveability actuator (3).

17. An unmanned vehicle according to claim 16, wherein the on-board electronic components (4) also comprise at least one source of electrical energy (42), and
wherein said at least one source of electrical energy (42) is located:
within the support (6) to also form the removable technical unit (5), or
directly on the frame (2), independently of said removable technical unit (5).

18. An unmanned vehicle according to claim 16, wherein the on-board electronic components (4) also comprise at least one instrument for acquisition (45), for taking images and/or for taking physical measurements, and
wherein said at least one instrument of acquisition (45) is located:
within the support (6) to also form the removable technical unit (5), or
directly on the frame (2), independently of said removable technical unit (5).

19. An unmanned vehicle according to claim 16, wherein the support (6) of the removable technical unit (5) is in the form of a box in which the on-board electronic components (4) are integrated.

20. An unmanned vehicle according to claim 19, wherein the support (6) of the removable technical unit (5) includes a front wall (62) forming a lid that is mobile between two positions:
an open position, for access to the on-board electronic components (4), and
a closed position, to prevent the access to said on-board electronic components (4).

21. An unmanned vehicle according to claim 16, wherein the vehicle frame (2) includes a place (21) in which is added said removable technical unit (5) and that is provided with an opening (211), and wherein the support (6) of the removable technical unit (5) includes a front wall (62) intended to close said opening (211).

22. An unmanned vehicle according to claim 21, wherein the front wall (62) has an aerodynamic profile.

23. An unmanned vehicle according to claim 16, wherein the support (6) of the removable technical unit (5) includes housings (611) for removably receiving the on-board electronic components (4).

24. An unmanned vehicle according to claim 16, wherein the mechanical/electrical interface means (7) comprise at least one power connector, a first part (71) of which is carried by the vehicle frame (2) and a second, complementary part (72) of which is carried by the removable technical unit (5).

25. An unmanned vehicle according to claim 16, wherein the vehicle frame (2) includes at least one carrier member chosen among:
at least one wing (2, 9, 10), adapted to ensure a driveability in the air carrier medium, and/or
at least one floater (11), adapted to ensure a driveability on the water carrier medium, and/or
means adapted to ensure a driveability on the terrestrial carrier medium.

26. An unmanned vehicle according to claim 25, wherein the wing consists in:
at least one fixed wing (2), and/or
at least one rotary-wing (9, 10), for example of the sustentation rotor type.

27. An unmanned vehicle according to claim 26, wherein the fixed wing (2) is a sailwing, including an intrados (28) and an extrados (29),
wherein said extrados (29) includes a place (21) for receiving the removable technical unit (5), and
wherein said removable technical unit (5) includes a front wall (62) having an aerodynamic profile to form a part of said extrados (29).

28. An unmanned vehicle according to claim 16, wherein the electronic/computer control system (41) includes:
piloting means adapted to the different vehicle frames able to be associated with the removable technical unit, and
means for the selection of piloting means adapted to the associated vehicle frame.

29. A system of unmanned vehicles according to claim 16, comprising:
a removable technical unit (5), and
at least two different vehicle frames (2).

30. A method for assembling an unmanned vehicle (1) according to claim 28, wherein the method comprises the following operations:
an operation of implantation of said removable technical unit (5) on the vehicle frame (2) by implementation of the mechanical/electrical interface means (7), and
an operation of selection of piloting means adapted to said associated vehicle frame (2), among the piloting means adapted to the different vehicle frames (2) able to be associated with said removable technical unit (5).
